(19) United States
(12) Patent Application Publication
(10) Pub. No.: US 2026/0296735 A1
(43) Pub. Date: Oct. 1, 2026

(54) Magnifying Container

(71) Applicant: Austen Epps, San Diego, CA (US)

(72) Inventor: Austen Epps, San Diego, CA (US)

(21) Appl. No.: 18/796,720

(22) Filed: Aug. 7, 2024

(51) Int. Cl. B65D 25/54; B65D 1/10; G02B 25/00

(52) U.S. Cl. CPC B65D 25/54; B65D 1/10; G02B 25/002

(57) ABSTRACT

A container formed of transparent material, such as glass, is provided which has a bottom portion configured for viewing the contents of the container. Formed into the bottom portion, preferably in a unitary structure therewith, is a lens which displays a magnified view of the container contents when viewed therethrough. An annular recess surrounding the exterior perimeter of the formed lens increases light communication for viewing.

### BACKGROUND OF THE INVENTION

### 1. Field of the Invention

The present invention relates generally to see-through containers, such as glass and plastic jars. More particularly, it relates to a see-through jar configuration having a bottom portion thereof which provides a magnified view of the contents held within an interior cavity of the jar.

### 2. Prior Art

In the field of containers, glass and plastic jars and the like have been employed for decades to hold both eatable and non eatable products. Conventional glass and plastic jars have a sidewall extending from a lower end portion of the jar to a distal or upper end of the sidewall.

The distal or top edge of the sidewall surrounds an opening which communicates with an interior cavity of the container which is surrounded by the sidewall. Adjacent the distal end of the sidewall are conventionally positioned connectors, such as threads, which are configured to removably engage with mating connectors such as mating threads formed on the interior surface of a lid sidewall. This allows the interior cavity to be sealed by the lid once the mating connectors on the lid have been engaged with the connectors formed on the sidewall of the jar body.

Particularly preferred for many such containers is the formation of the body of the container in a clear or otherwise see-through material, such as glass and plastic. This see-through configuration allows the user to view the contents through the sidewall if the lid is engaged to the jar body and blocking the view through the opening.

With respect to the above, before explaining at least one preferred embodiment of the magnifying container herein, it is to be understood that the disclosed container device and system are not limited in application to the details of employment and to the arrangement of the components or the steps set forth in the following description or illustrated in the drawings. The various container apparatus and operations of the herein disclosed magnifying container are capable of other embodiments, and of being practiced and carried out in various ways, all of which will be obvious to those skilled in the art once the information herein is reviewed.

Also, it is to be understood that the phraseology and terminology employed herein are for the purpose of description, and should not be regarded as limiting. As such, those skilled in the art will appreciate that the conception upon which this disclosure is based, may readily be utilized for other see through magnifying container systems. It is important, therefore, that the embodiments, objects and claims herein, be regarded as including such equivalent construction and methodology insofar as they do not depart from the spirit and scope of the present invention.

### SUMMARY OF THE INVENTION

The magnifying container system herein, disclosed and described, provides a see-through container which is configured for engagement to a lid which covers an opening to an interior cavity therein. At least a bottom portion of the body forming the container and preferably the sidewall defining the interior cavity is formed of a see-through or transparent polymeric or glass material.

A lens is positioned in a bottom portion of the body of the container which is employable by a user to see the contents of the container in a magnified view. The lens may be bi-convex or plano convex depending on the degree of magnification desired and the height of the interior cavity at which a focused view of the contents therein is desired.

With respect to the above description, before explaining at least one preferred embodiment of the herein disclosed magnifying container system herein, it is to be understood that the invention is not limited in its application to the details of construction and to the arrangement of the components in the following description or illustrated in the drawings. The container invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based, may readily be utilized as a basis for designing of other magnifying containers, and for carrying out the several purposes of the present disclosed container device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Finally, the term “substantially” if not otherwise defined for size or dimension or positioning of a specific part or configuration, means plus or minus ten percent.

It is an object of this invention to provide a configuration for a bottom portion of a container which will provide the user a magnified view of the contents within the interior cavity of the container.

Other objects, features, and advantages of the present magnifying container device and system, as well as the advantages thereof over existing prior art, will become apparent from the description to follow and are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features of the various modes of the magnifying container invention herein which as noted may be employed singularly or in combination. It is intended that the embodiments and figures disclosed herein are to be considered illustrative rather than limiting.

In the drawings:

FIG. 1 depicts an overhead perspective view of the magnifying container device herein showing the see-through or substantially transparent sidewall defining an interior cavity and showing an opening at a upper end of the sidewall, and a bottom portion of the container having a planar-convex or bi-convex magnifying lens formed therein.

FIG. 2 shows a sectional view through a mode of the container device having a bi-convex lens formed into the bottom portion thereof.

FIG. 3 depicts a mode of the container device herein having a planar-convex lens formed into the bottom portion of the container.

FIG. 4 depicts an example of the container of FIGS. 1-3 in use to enlarge or magnify the view of the contents of the interior cavity of the container when viewed through the magnifying lens formed into the bottom portion thereof.

FIG. 5 depicts sectional views through differently configured container devices, as herein disclosed, showing a container with a bi-convex lens formed into the bottom portion and a container with plano-convex lens formed therein.

FIG. 6 depicts sectional views through smaller sized container devices from that of FIGS. 1-5, as herein disclosed, showing a smaller volume container with a bi-convex lens formed into the bottom portion and a smaller volume container with a bi-convex lens formed therein.

FIG. 7 depicts sectional views through smaller sized container devices from that of FIGS. 1-6, as herein disclosed, showing a smaller volume container with a bi-convex lens formed into the bottom portion and another smaller volume container with a plano-convex lens formed therein.

FIG. 8 shows an example of a formula for determining the curvature of the formed magnifying lens and whether it should be formed planar-convex or bi-convex in order to magnify contents of the interior cavity for a desired entire or partial distance f above the bottom portion of the body of the container.

FIG. 9 depicts a perspective view of the container having a rectangular base.

FIG. 10 shows a perspective bottom view of the container, as in FIG. 9.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right, first, second, and other such terms refer to the device as it is oriented and appears in the drawings and are used for convenience only, and they are not intended to be limiting or to imply that the magnifying container device herein has to be used or positioned in any particular orientation.

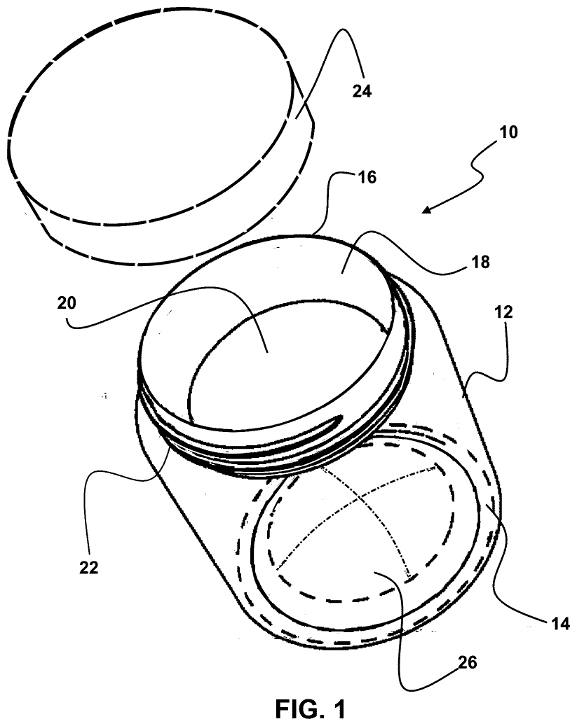

Now referring to drawings in FIGS. 1-10 wherein similar components are identified by like reference numerals, there is seen in FIG. 1 an overhead perspective view of the magnifying container device 10 herein. As shown, the container device 10 can be formed of material which is transparent or substantially see-through with a sidewall 12 which extends from a first end thereof at a bottom portion 14 of the container device 10 to an upper end 16.

The sidewall 12 at the upper end 16 encircles and defines an opening 18 which communicates with an interior cavity 20 of the container device 10. This interior cavity 20 is configured to hold eatable or non eatable material therein for storage within the container device 10. At or adjacent the upper end 16 of the sidewall 12 are formed sidewall connectors 22, such as threads, which are configured to removably engage with mating lid connectors, such as mating threads (not shown but well known) formed into a lid 24 which is configured to removably engage with the container device 10. The lid 24, once removably engaged, will serve to close the opening 18 and hold any contents within the interior cavity 20 of the container device 10. Threads on the sidewall 12 may form the sidewall connector 22 which is configured to removably engage mating threads on the lid 24, for example, but other engagements may be employed to hold the lid 24 to the container device 10 and such are anticipated within the scope of this application and claims herein.

Also shown in FIG. 1 is a magnifying lens 26 formed into or as part of the bottom portion 14 of the container device 10 from which the sidewall 12 extends. As noted herein and as can be determined by the calculations of FIG. 8 for depth of field and distance for focus, the magnifying lens 26 formed may be plano-convex or bi-convex in configuration as shown in the various figures herein.

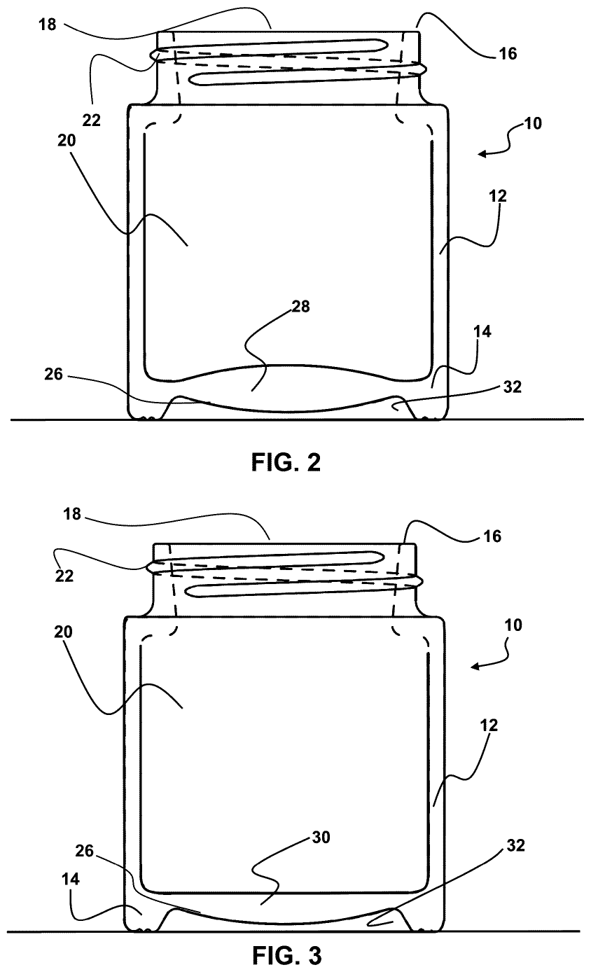

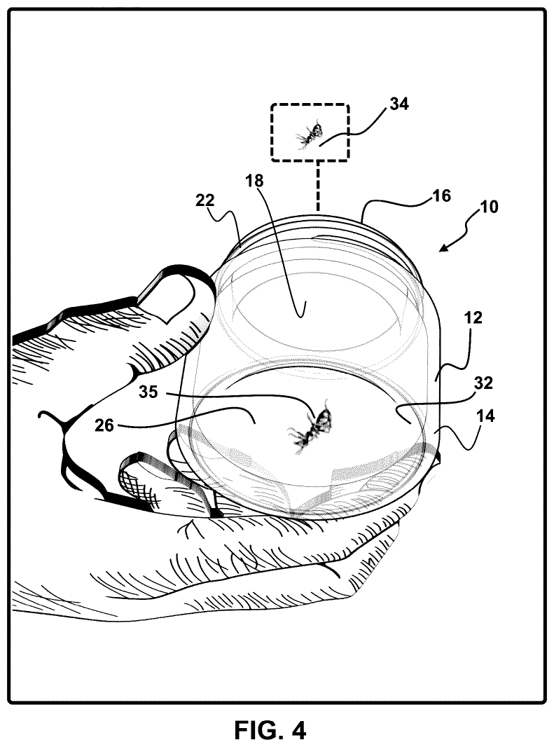

FIG. 2 depicts a sectional view through a mode of the container device 10 herein. As shown in this mode the bottom portion 14 has a bi-convex 28 magnifying lens 26 formed therein. This mode provides for more magnification of the contents of the interior cavity 20 than the planar convex 30 mode of the magnifying lens 26, shown in FIG. 3 and per the determination of FIG. 8, may work well for a container device 10 having a longer sidewall 12 and a need for a larger depth of field in the magnification when viewed therethrough as in FIG. 4.

Also shown in FIG. 3 and FIG. 4 and other sectional views herein is an annular recess 32 which is formed into the bottom portion 14 and surrounds the magnifying lens 26. While the container device 10 will work without the annular recess 32, during experimentation with various forms of the container device 10, it was found by surprise that the annular recess 32 helped to communicate more ambient light into the interior cavity 20 of the container device 10 and thus allowed for a larger and a significantly more curved magnifying lens 26 to be formed. This allowed for much better magnification where the formed magnifying lens 26 is a planar convex lens 30 by allowing for a steeper curve to the formed magnifying lens 26. As such, the inclusion of the annular recess 32 is preferred in configurations of the container device 10 herein which need more light transmission into the interior cavity 20 to the area adjacent the magnifying lens 26 formed into the bottom portion 14 of the container device 10.

In FIG. 3 is shown a mode of the container device 10 herein having a magnifying lens 26 formed in a unitary structure with the entire container device 10 structure, such as in the bottom portion 14 thereof, which is shown configured as a planar-convex 30 lens. It was also found that forming any type of magnifying lens 26 for the container device 10 herein as a unitary structure and part of the bottom portion 14 worked best for the clearest viewing of the contents of the interior cavity 20 since adhering a magnifying lens 26 to the bottom portion 14 would yield visual aberration. Also shown is the preferred encircling or annular recess 32 which depends into the exterior of the bottom portion 14 of the container device 10 body and surrounds the perimeter end of the formed magnifying lens 26.

In FIG. 4 is a depiction of the container device 10 herein in use wherein the contents 34 of the container device 10 may be viewed through the magnifying lens 26 and is viewable in a magnified image 35 of the contents 34. This magnified image 35 is provided whether the magnifying lens 26 is formed in a bi-convex 28 configuration or a plano convex 30 configuration. Also shown is the preferred annular recess 32 which is formed into the exterior surface of the bottom portion 14 of the container device 10 body.

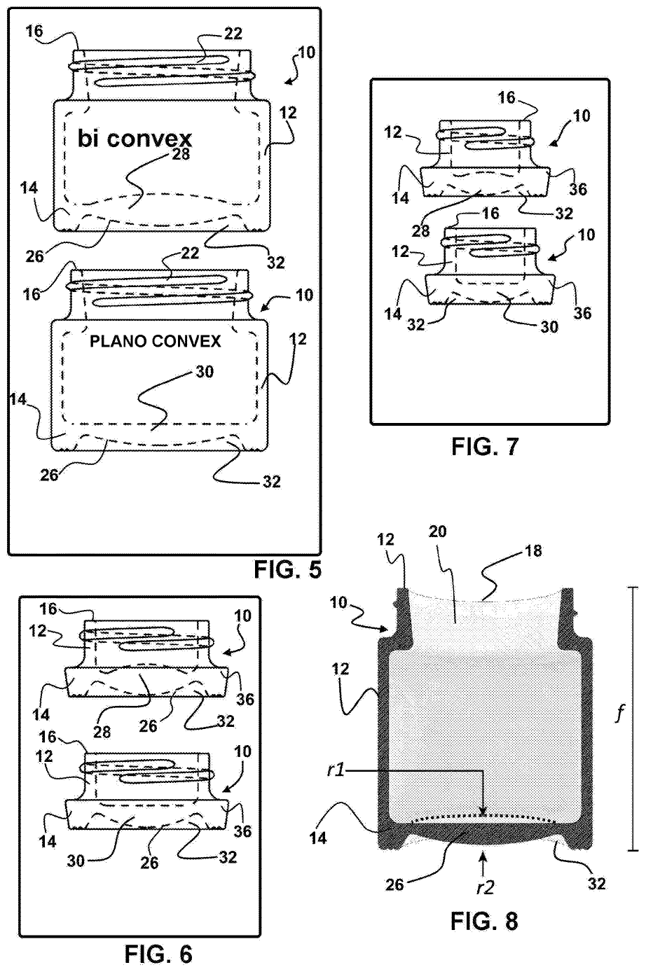

FIGS. 5-7 depict various configurations of the container device 10 herein where the interior cavity 20 is of a larger or smaller size as dictated by the length of the sidewall 12 from the first side at the bottom portion 14 to the upper end 16 thereof. As noted, the magnifying lens 26 may be formed in either the bi-convex 28 or plano-convex 30 configuration depending on the area of the internal cavity 20 for which the magnified view of the contents 34 is desired.

Shown in FIG. 8 is an example of a means to determine the shape of the magnifying lens 26 and the shape of one or two curved surfaces r1 and r2. The further the distance f into the interior cavity 20, for which a clear magnified view of the contents 34 is to be provided, the steeper the curve r2 of either the planar-convex lens 30 is formed, and/or the inclusion and steepness of the curve r1 of a bi-convex lens 28, if used.

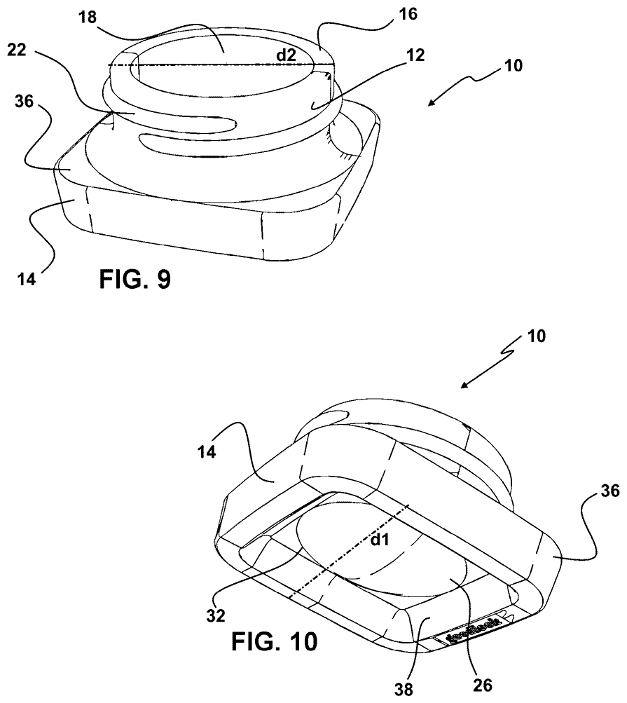

As noted, shown in FIG. 9 is a perspective view of the container device 10 herein having a rectangular bottom portion 14 which extends in a shoulder 36 which is wider than the diameter of the upper end 16. The shoulder extends entirely around the outside surface of the sidewall 12. By a diameter wider than the diameter of the upper end 16 is meant that the bottom portion 14 having a shoulder 36 therearound has a shoulder diameter d1 running across said bottom portion 14 to opposing ends on opposite sides of said shoulder 36 which is larger than a sidewall diameter d2 running across the opening 18 and opposing portions of said sidewall 16 on opposite sides of said opening 18.

The container device 10, as in FIG. 9, is shown in FIG. 10 in a perspective bottom view of the container device 10. In this configuration, as noted, the bottom portion 14 is configured with a shoulder 36. Between an inner edge 38 of this shoulder 36 and the perimeter edge 40 of the magnifying lens 26 is positioned the annular recess 32 which in this configuration is somewhat rectangular in its surrounding of the magnifying lens 26. With the shoulder 36 formed of clear material, such as glass or plastic, when tilting the container device 10, the shoulder forms a lens where light may be directed through the shoulder 36 and into the internal cavity 20 to increase viewability of the contents 34 through either type of magnifying lens 26 noted herein.

The description of the features of the magnifying container device and system invention herein, does not limit the claims of this application, and other applications developed by those skilled in the art upon reviewing this application are considered to be included in this invention.

It is additionally noted and anticipated that although the magnifying container herein is shown in its most simple form and potential configurations, various components and aspects of the disclosed container device may be differently shaped or slightly modified when forming the invention herein. As such, those skilled in the art will appreciate the descriptions and depictions set forth in this disclosure are merely meant to portray examples of preferred modes of the magnifying container herein within the overall scope and intent of the invention, and are not to be considered limiting in any manner.

Further, while all of the fundamental characteristics and features of the magnifying container invention have been shown and described herein, with reference to particular embodiments thereof, a latitude of modification, various changes and substitutions are intended in the foregoing disclosure as well as the claims which follow, and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A container apparatus comprising:
a container body, said container body having a sidewall, said sidewall extending from a bottom portion of the container body to an upper end of the sidewall, said container body formed of transparent material;
an opening defined by an interior edge of said sidewall encircling said opening at said upper end, said opening communicating with an interior cavity of said container body, said interior cavity for holding container contents therein;
a sidewall connector located adjacent to said upper end on an exterior surface of said sidewall, said sidewall connector for engaging with a lid; and
a magnifying lens formed into said bottom portion, said magnifying lens providing a view of said container contents therethrough, whereby the container contents is viewable through said magnifying lens.

2. The container apparatus of claim 1, further comprising:
said magnifying lens if formed as a unitary structure with said container body.

3. The container apparatus of claim 1, further comprising:
a recess formed into said bottom portion, said recess surrounding a perimeter edge of said magnifying lens.

4. The container apparatus of claim 2, further comprising:
a recess formed into said bottom portion, said recess surrounding a perimeter edge of said magnifying lens.

5. The container apparatus of claim 1, wherein said magnifying lens is one of a bi-convex lens or a plano convex lens.

6. The container apparatus of claim 2, wherein said magnifying lens is one of a bi-convex lens or a plano convex lens.

7. The container apparatus of claim 3, wherein said magnifying lens is one of a bi-convex lens or a plano convex lens.

8. The container apparatus of claim 4, wherein said magnifying lens is one of a bi-convex lens or a plano convex lens.

9. The container apparatus of claim 1 additionally comprising:
said bottom portion having a shoulder therearound, a shoulder diameter of said shoulder being larger than a sidewall diameter of said sidewall encircling said opening at said upper end, wherein said shoulder projects away from said sidewall.

10. The container apparatus of claim 2 additionally comprising:
said bottom portion having a shoulder there around, a shoulder diameter of said shoulder being larger than a sidewall diameter of said sidewall encircling said opening at said upper end, wherein said shoulder projects away from said sidewall.

11. The container apparatus of claim 3 additionally comprising:
said bottom portion having a shoulder there around, a shoulder diameter of said shoulder being larger than a sidewall diameter of said sidewall encircling said opening at said upper end, wherein said shoulder projects away from said sidewall.

11. The container apparatus of claim 4 additionally comprising:
said bottom portion having a shoulder there around, a shoulder diameter of said shoulder being larger than a sidewall diameter of said sidewall encircling said opening at said upper end, wherein said shoulder projects away from said sidewall.

12. The container apparatus of claim 9 wherein said shoulder is rectangular in shape and said sidewall extending from said bottom portion of the container body to said upper end of the sidewall forms a circular column.
